(19) United States
(12) Patent Application Publication
(10) Pub. No.: US 2008/0298917 A1
(43) Pub. Date: Dec. 4, 2008

(54) Disposable Cutter

(76) Inventor: Hsin-Tien Chang, Tai-Ping City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/757,612

(22) Filed: Jun. 4, 2007

(51) Int. Cl. B26D 3/00

(52) U.S. Cl. 408/226

(57) ABSTRACT

A disposable cutter includes a multi-side body including a top surface, a bottom, and a plurality of sides. A stepped hole is defined through the body and a bolt extends through the stepped hole to fix the disposable cutter to a shank. Each of the sides is inclined an angle relative to a vertical line. A recessed area is defined in the top surface and at least one inclined surface is connected between the top surface and the recessed area. A safety edge is defined between the top surface and the side connected with the top surface. At least one inclined surface is directly connected with a cutting edge. The cutting edge and the safety edge are located on two sides of a line passing through a center of the stepped hole. The safety edge contacts an inner periphery of the hole so as to provide a support to the disposable cutter.

### FIELD OF THE INVENTION

The present invention relates to a disposable cutter with a cutting edge and a safety edge which provides support to avoid shaking of the disposable cutter.

### BACKGROUND OF THE INVENTION

A conventional drill bit 3 is shown in FIG. 11 and generally is made from tungsten steel which is expensive and difficult to be cut to a desired shape. The conventional drill bit 3 includes two cutting edges 31 and each cutting edge 31 generates a resistance “R” when drilling an object so that the conventional drill bit 3 is applied by two resistances “R” which force the drilling speed to reduce otherwise the drill bit might be damaged.

A conventional disposable cutter 4 is disclosed in FIG. 12 and is fixed to an end of a shank 40. A lip angle θ of the disposable cutter 40 is 55 degrees and an angle between the central axis 400 of the shank 40 and the cutting edge 411 is 30 degrees. An angle α between the mirror image of the cutting edge 411 about the central axis 400 and the cutting edge 411 is 60 degrees. As shown in FIG. 13, an angle φ between the mirror image 412 of the cutting edge 411 about the central axis 400 and the other cutting edge 410 is 5 degrees. Therefore, the cutting edge 412 does not cut the object so that only the cutting edge 411 generates a resistance “R” when drilling a hole. Although the resistance “R” is smaller than the sum of two “R” of the conventional drill bit as described in FIG. 11, the resistance “R” on one side of the disposable cutter 4 results in shaking to the disposable cutter 4. The shaking also affects the speed of the operation of the disposable cutter 4.

The present invention intends to provide a disposable cutter that includes a safety edge which contacts the inner periphery of the hole to provide a support to the disposable cutter so that the disposable cutter can drill at high speed.

### SUMMARY OF THE INVENTION

The present invention relates to a disposable cutter for drilling bit and includes a multi-side body with a top surface, a bottom, and a plurality of sides. Two curved portions are defined in two sides of the body and connected to the bottom. A stepped hole is defined through the body. Each of the sides is inclined an angle β relative to a vertical line. A recessed area is defined in the top surface and at least one inclined surface is connected between the top surface and the recessed area. At least one surface is connected with a cutting edge. The cutting edge and the safety edge are located on two sides of a line passing through a center of the stepped hole. The safety edge contacts an inner periphery of the hole so as to provide a support to the disposable cutter.

The primary object of the present invention is to provide a disposable cutter that uses one cutting edge to drill a hole while a safety edge provides a support to the disposable cutter so that the disposable cutter does not shake during drilling the hole.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the disposable cutter of the present invention;

FIG. 2 shows the disposable cutter of the present invention, viewed from the bottom at an angle of the disposable cutter;

FIG. 3 is a top view of the disposable cutter of the present invention;

FIG. 4 is a cross sectional view along line A-A in FIG. 3;

FIG. 5 shows a shank with which the disposable cutter of the present invention is to be connected;

FIG. 6 shows that the disposable cutter of the present invention is connected with the shank;

FIG. 7 is a side view to show that the disposable cutter is connected to the shank;

FIG. 8 shows that the disposable cutter drills a hole and a support is provided to the safety edge;

FIG. 9 shows that the disposable cutter is making a groove;

FIG. 10 shows that the disposable cutter is making a rounded edge;

FIG. 11 shows a conventional drill bit;

FIG. 12 shows a conventional disposable cutter is connected to a shank, and

FIG. 13 shows that the conventional disposable cutter drills a hole.

### DETAILED DESCRIPTION OF THE PREFERRED EMBODIMENT

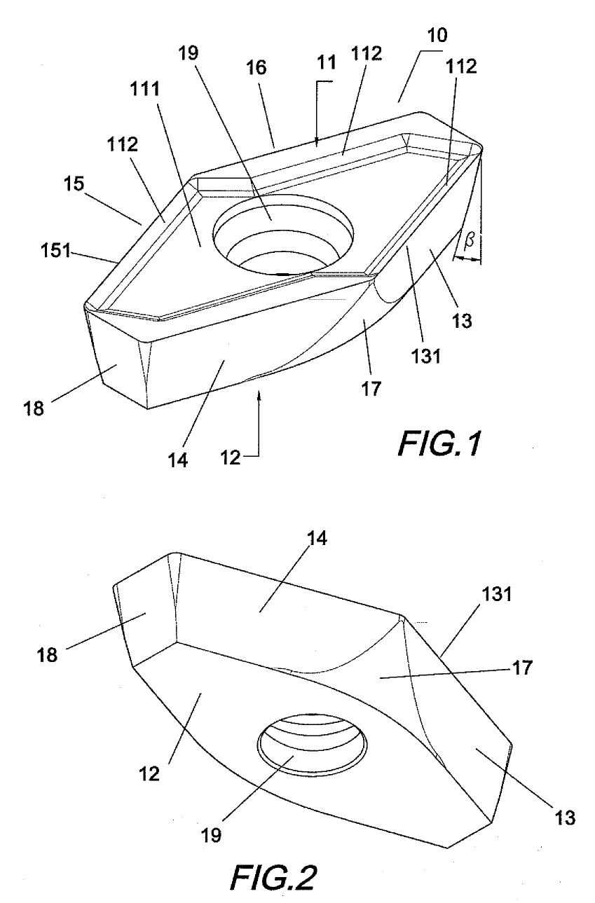

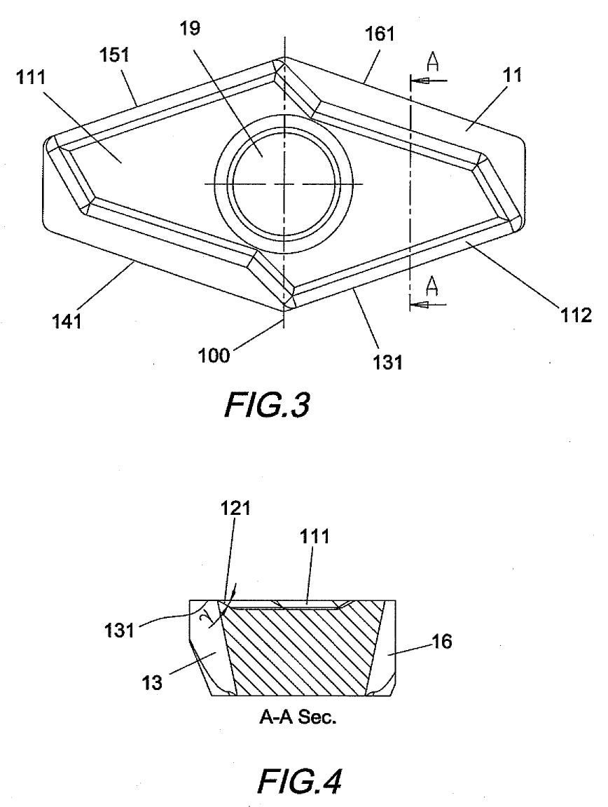

Referring to FIGS. 1 to 4, the disposable cutter 10 of the present invention is a multi-side body, in this embodiment, the multi-side body is substantially a diamond-shaped body which comprises a top surface 1, a bottom 12, and a plurality of sides 13, 14, 15 and 16. Two curved portions 17 are defined in two sides of the body and connecting to the bottom 12, and two sides 18 are made to be a flat surface. A stepped hole 19 is defined through the body. Each of the sides 13, 14, 15 and 16 is inclined an acute angle β relative to a vertical line. A recessed area 111 is defined in the top surface 11 and two inclined surfaces 12 are connected between the top surface 11 of the side 14 and 16, and a vertical inside of the recessed area 111. The other two inclined surfaces 112 are directly connected with two respective cutting edges 131, 151. An acute included angle γ is defined between the inclined surface 121 and the top surface 11 as shown in FIG. 4.

A safety edge 141/161 is defined along a ridge connected between the top surface 11 and the side 14/16. The safety edge 141 and the cutting edge 131 are located on two sides of a line 100 passing through a center of the stepped hole 19.

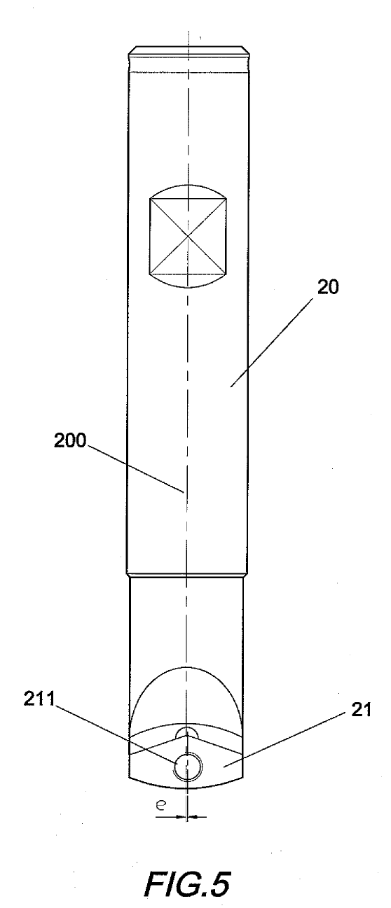

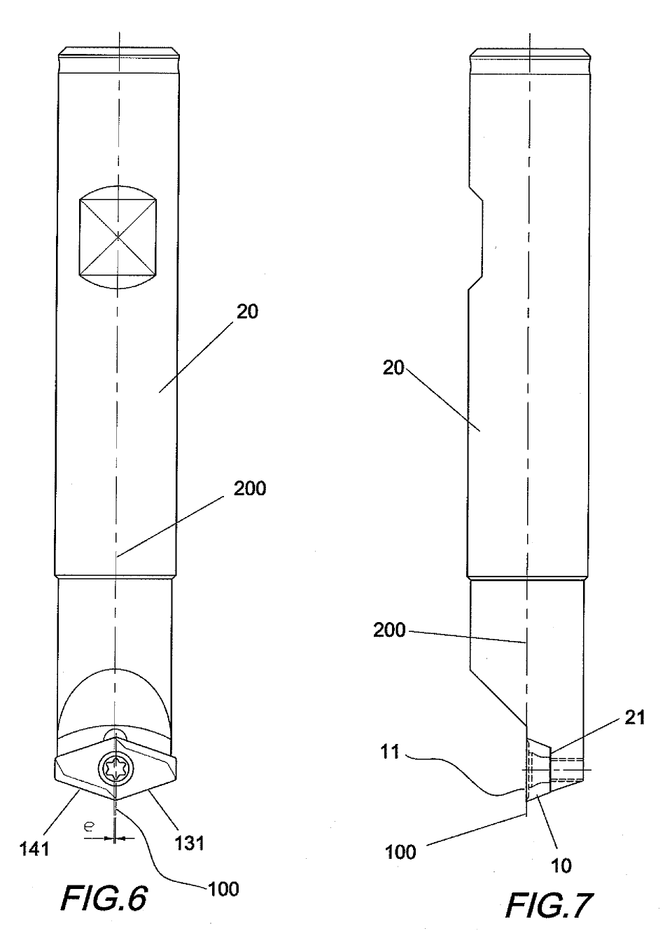

As shown in FIGS. 5 to 7, a shank 20 having a reception area 21 and a threaded hole 211 defined in the reception area 21. The disposable cutter 10 is engaged with the reception area 21 of the shank 20 by a bolt extending through the stepped hole 19 of the disposable cutter 10 and engaged with the threaded hole 211. The line 100 passing through the center of the stepped hole 19 (or a line passing through a center of the threaded hole 211) and a central axis 200 of the shank 20 are parallel to each other and a distance “e” is defined between the line 100 of the disposable cutter 10 (or a line passing through a center of the threaded hole 211) and the central axis 200 of the shank 20. The distance “e” is within a range from 0.05 mm to 0.1 mm.

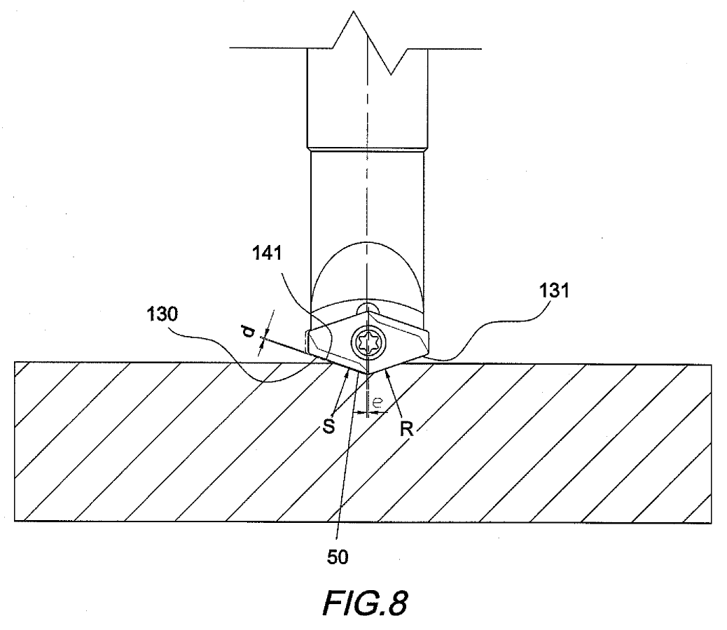

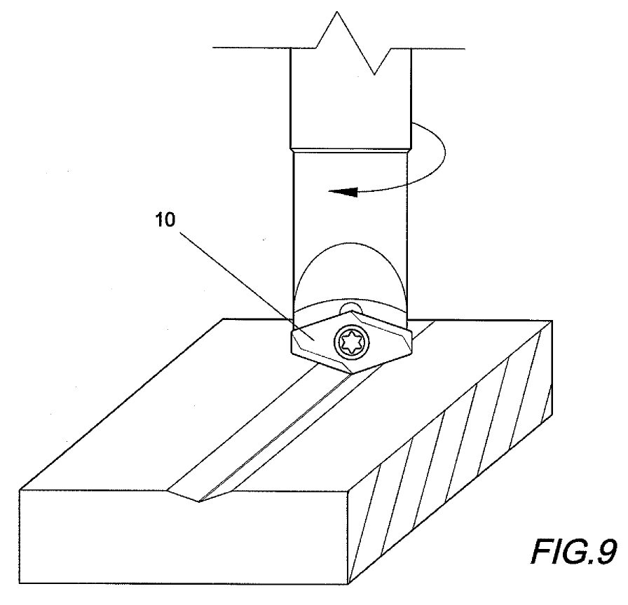

As shown in FIG. 8, a distance “d” is defined between a mirror image of the cutting edge 131 about the central axis 200 of the shank 20 and the safety edge 141. In other words, the mirror image of the cutting edge 131 about the central axis 200 of the shank 20 is slightly lower than the safety edge 141 when viewed from the position of FIG. 8. When drilling a hole, only the cutting edge 131 performs the cutting function and safety edge 141 does not perform the cutting function. The distance “d” is so small that when the disposable cutter 10 proceeds drilling process, the resistance “R” deforms the shank 20 slightly so that the safety edge 141 is in contact with an inner periphery of the hole 50. The inner periphery of the hole 50 provides a support force “S” which balances the resistance “R”, so that the disposable cutter 10 does not shake and the speed of the drilling process can be faster. When the distance “e” is 0.1 mm, the distance “d” is 0.065 mm, and when the distance “e” is 0.05 mm, the distance “d” is 0.0325 mm.

After the drilling process is complete, the shank 20 stops for ½ second and the disposable cutter 10 bounces back to its original position relative to the inner periphery of the hole 50.

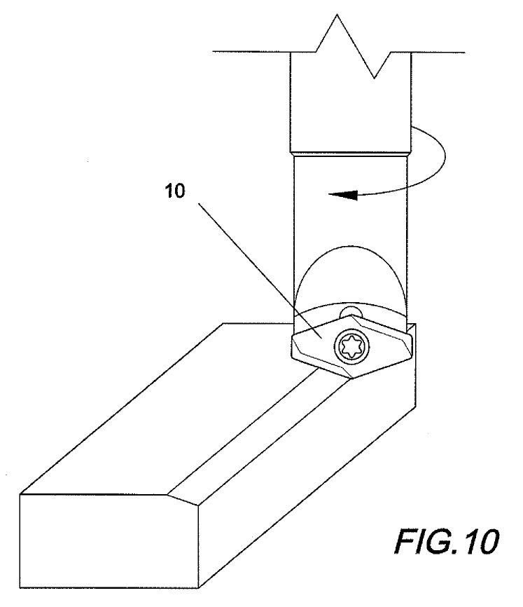

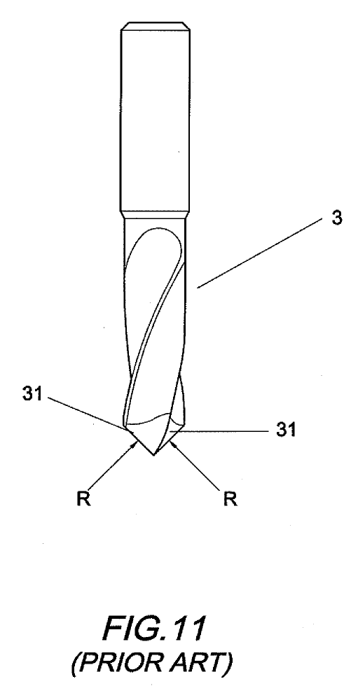

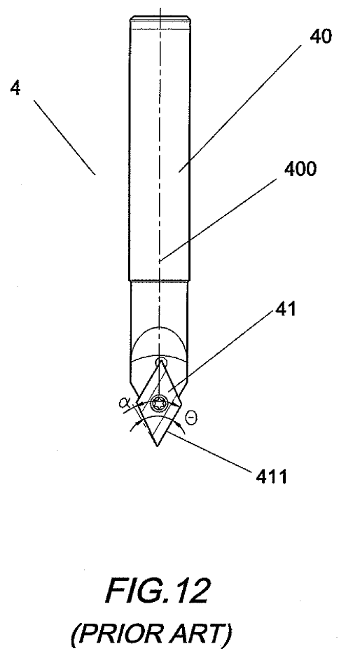

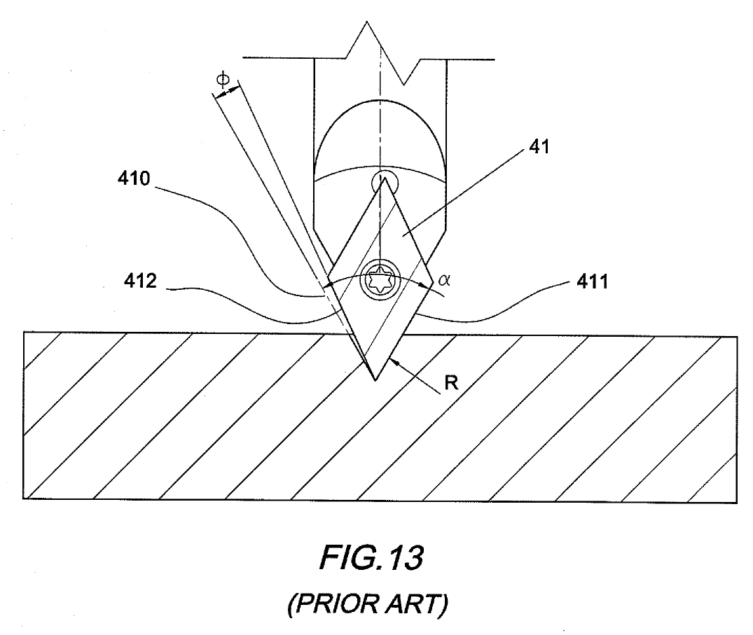

FIGS. 9 and 10 show that the disposable cutter 10 can also be used to engrave, make a groove and make rounded edge.

While we have shown and described the embodiment in accordance with the present invention, it should be clear to those skilled in the art that further embodiments may be made without departing from the scope of the present invention.

What is claimed is:

1. A disposable cutter comprising:
a multi-side body which includes a top surface, a bottom, and a plurality of sides, two curved portions defined in two sides of the body and connecting to the bottom, a stepped hole defined through the body, each of the sides being inclined an angle relative to a vertical line, a recessed area defined in the top surface and at least one inclined surface connected between the top surface and the recessed area, at least one surface being directly connected with a cutting edge.

2. The disposable cutter as claimed in claim 1 further comprising a shank which has a reception area and a threaded hole is defined in the reception area, a first distance is defined between a first line passing through a center of the threaded hole and a central axis of the shank, the disposable cutter is connected to the reception area of the shank by a bolt extending through the stepped hole in the disposable cutter and engaged with the threaded hole in the shank.

3. The disposable cutter as claimed in claim 2, wherein a safety edge is defined along a ridge connected between the top surface and the side connected with the top surface, the safety edge and the cutting edge are located on two sides of a second line passing through a center of the stepped hole, a second distance is defined between a mirror image of the cutting edge about the central axis of the shank and the safety edge.

4. The disposable cutter as claimed in claim 2, wherein a safety edge is defined along a ridge connected between the top surface and the side connected with the top surface, the safety edge and the cutting edge are located on two sides of a second line passing through a center of the stepped hole, a second distance is defined between a mirror image of the cutting edge about the central axis of the shank and the safety edge, the second distance is smaller than the first distance.
